(19) United States
(12) Patent Application Publication
(10) Pub. No.: US 2020/0315219 A1
(43) Pub. Date: Oct. 8, 2020

(54) Method For Processing Plant Leaves And Method For Producing A Fermented Product From Plucked Plant Leaves, Comprising Conditioning The Plant Leaves By Applying An Electric Field

(71) Applicant: ELEA VERTRIEBS-UND VERMARKTUNGSGESELLSCHAFT MBH, Quakenbruck (DE)

(72) Inventors: Robin Ostermeier, Osnabruck (DE); Stefan Toepfl, Osnabruck (DE); Julian Witt, Osnabruck (DE)

(21) Appl. No.: 16/649,774

(22) PCT Filed: Oct. 4, 2018
(86) PCT No.: PCT/EP2018/076982

§ 371 Date: Mar. 23, 2020

(30) Foreign Application Priority Data
Oct. 4, 2017 (DE) 10 2017 217 623.7

(51) Int. Cl. A23L 3/32; A23B 7/015; A23F 3/10; A23F 3/12; A23L 3/40; A24B 15/20; A24B 15/22; A24B 3/18

(52) U.S. Cl. CPC A23L 3/32; A23B 7/015; A23F 3/10; A23F 3/12; A23V 2002/00; A24B 15/20; A24B 15/22; A24B 3/18; A23L 3/40

(57) ABSTRACT

The present invention relates to a method for processing plant leaves, in particular in the context of producing a fermented product, and to a method for producing a fermented product from plucked plant leaves, comprising the steps: optionally withering the plant leaves, optionally rolling the plant leaves, optionally fermenting the plant leaves, and drying the plant leaves. In order to reduce the expenditure in costs, time and energy of conventional methods for processing plant leaves and for producing a fermented product from plucked plant leaves, respectively, it is provided according to the invention that the plant leaves are conditioned by applying an electric field.

The present invention relates to a method for processing plant leaves, for example, tea or tobacco leaves, in particular in the context of producing a fermented product, as well as plant leaves which are produced using this method.

The invention further relates to a method for producing a fermented product from plucked plant leaves, for example, a tea product or a tobacco product, comprising the steps: optionally withering the plant leaves, optionally rolling the plant leaves, optionally fermenting the plant leaves and drying the plant leaves, as well as a plant leaf product or a fermented product from plant leaves, for example, a tea or tobacco product which is produced using of this method.

A number of fermented products are produced from plant leaves, for example, tea and tobacco products, or herbs and spices.

From the tobacco plant, in particular its leaves, a plurality of products is made, such as tobacco or snuff, as well as concentrates and extracts for the use in e-cigarettes, evaporators and similar products.

A plurality of tea products is produced from the tea plant (Camellia sinensis), in particular its leaves, for example, leaf tea, tea beverages, concentrates or a dried powder produced from a tea leaf extract or a tea beverage.

Leaf tea can be produced as green leaf tea or black leaf tea. In order to produce black leaf tea, fresh leaves of the tea plant are withered, i.e. subjected to gentle drying, then crushed, fermented and subsequently dried. During fermentation, enzymes in the tea leaf are exposed to atmospheric oxygen in order to oxidize various substances and produce a brown-colored product. Green leaf tea is not exposed to the fermentation process. Partial fermentation can also be used to produce an intermediate type of tea known as “Oolong” tea.

In the production of tea, in particular black tea, the fermentative enzymes and their substrates within the leaves are released. This is done mechanically, for which two main methods are distinguished.

The first, so-called “orthodox production” involves rolling withered tea leaves prior to the fermentation step. When being rolled, the leaves are broken open with the aid of press spindles or rollers, so that cell juice leaks out.

The second method is the CTC (cut-tear-cud), in which the tea leaves are broken, tom and rolled in one process step after withering. The resulting finely cut product is characterized by a rapid infusion speed and a strong color.

For the purposes of this application, the processing step of rolling comprises both the orthodox production as well as the CTC method.

The tea production method is basically very time-consuming, energy-consuming and costly.

The withering process can take up to 24 hours. Withering can indeed be accelerated by ventilating the plucked tea leaves with fans and, possibly, by heating them, which can shorten the withering time, but only with considerable energy consumption.

The process steps of rolling, fermenting and drying also require a considerable amount of time and energy. The same applies for the production of tobacco products.

It is therefore the object of the present invention to provide a method for processing plant leaves and a method for producing a fermented product from plucked plant leaves, respectively, which reduces the expenditure in time, cost and energy of the conventional process.

This object is solved according to the invention with a method for processing plant leaves, in particular in the context of producing a fermented product, in which the plant leaves are conditioned by applying an electric field. The method mentioned above for producing a fermented product from plucked plant leaves satisfied this object in that the plant leaves are further conditioned according to the method of the invention for processing plant leaves, i.e. by applying an electric field.

The present invention has surprisingly shown that conditioning the plant leaves by applying an electric field can lead to the acceleration of the withering process, and that the degree of oxidation and thereby the color as well as also the taste and the aroma of the product can be controlled. In addition, it was surprisingly observed that the expenditure in time and energy for the subsequent production steps can be significantly reduced.

The invention can be further improved by the following developments, which are advantageous each by itself and can be combined with one another as desired, and advantageous embodiments.

According to one embodiment, the plant leaves can be tea leaves, tobacco leaves, herb leaves or spice leaves. The product produced would then be a tea product, a tobacco product, a herbal product or a spice product.

According to one embodiment, a pulsed electric field causing cell disruption can be applied during the conditioning. Therefore, electroporation takes place in which the semi-permeability of the cell membrane of the plant cell is removed by applying an electric field, in particular a pulsed electric field. The removal of the semi-permeability and the associated cell disruption improves mass transport within the cell structures. The semi-permeability of the cell membrane can be reversibly or irreversibly removed, whereby irreversible electroporation is preferred, because the permanent removal of the semi-permeability allows for more flexibility in the sequence of the individual method steps.

Conditioning by applying a pulsed electric field, in the following also PEF (pulsed electric field), induces the cell disruption, which results in more rapid withering and softening of the plant leaves, for example, tea or tobacco leaves. Furthermore, a PEF-induced cell disruption enhances the release of endogenous enzymes from the cells of the plant leaves which accelerates fermentation, i.e. enzymatic oxidation For example, polyphenols relevant for the formation of color as well as hydrolysis of leaf proteins in peptides and amino acids, which are relevant for the formation of taste, are enhanced by the conditioning according to the invention.

A predetermined degree of disruption of the plant leaves can further be adjusted by conditioning according to the invention. PEF treatment according to the invention therefore enables having selective influence on the cell disruption and the activity of endogenous enzymes, so that lower fermentation and oxidation times can be obtained and a desired degree of oxidation, for example, from 5% to 100%, can be adjusted in a controlled, rapid and energy-efficient manner.

According to a further embodiment, the plant leaves can be conditioned prior to withering, prior to rolling, during withering, during rolling, prior to fermenting and/or prior to drying, in dependence of which method step is to be selectively improved. Conditioning prior to withering achieves good product properties.

According to one further embodiment, the step of conditioning can replace in whole or in part the step of withering and/or the step of rolling. Conditioning according to the invention achieves cell disruption which can replace at least in part the mechanical cell disruption methods, for example, shredding, tumbling, breaking or rolling, thereby saving time and energy. In addition, it has surprisingly been found that a PEF treatment with subsequent rolling of the plant leaves, which also serves shaping, causes a reduced breaking tendency, so that the method according to the invention improves product quality.

During conditioning, an energy input of at least 0.1 kJ/kg, preferably an energy input of 0.1 kJ/kg to 10 kJ/kg and most preferably from 0.5 to 3 kJ/kg can be effected into the plant leaves. An energy input of this magnitude is well suited to perform irreversible electroporation and to achieve cell disruption in the framework of conditioning.

It has also shown that it is advantageous to have an electric field from 0.1 kV/cm to 10 kV/cm, preferably from 0.5 kV/cm to 2 kV/cm be applied. Such field strengths can be obtained with a commercially available industrial capacitors and prevent unwanted thermal effects arising during the conditioning of the plant leaves, which would lead to unwanted alterations of the plant leaves.

The electric field, in particular, the electrical pulses, can be generated both by direct contact of the capacitor or its electrodes, respectively, with the plant leaves, as well as by way of conductive fluids, where the plant leaves are immersed in whole or in part into the conductive fluids. Different electrode shapes can there be employed, for example plate, ring, grid, hollow or flow-through electrodes.

Conditioning can be carried out in batch as well as in continuous operation. Continuous conditioning can be carried out, for example, in a water bath by using conveyor belts for transporting the plant leaves or, in order to reduce the addition of water, by using a transport auger with an electrode system introduced.

For example, a high voltage pulse generator can be used as a pulse generator, which generates electric fields in the form of short pulses in the micro to millisecond range at a high voltage in the kilovolt range. Marx generators can be used as high-voltage pulse generators.

In terms of time and energy optimization, the plant leaves can be conditioned with at least 10 electrical pulses, preferably 10 to 200 electrical pulses, and most preferably 30 to 50 electrical pulses.

The electric field applied can be, in particular, a non-thermally acting electric field in which the upper energy limit is determined such that substantially no heating of the food products in the sense of ohmic heating takes place. In this way, the method according to the invention can open the plant leaves non-thermally, and also non-mechanically during conditioning and prepare the plant leaves for a subsequent processing step of withering, rolling, fermenting and/or drying.

In one embodiment of the method according to the invention for producing a fermented product from plucked plant leaves, the plant leaves can wither less than 8 hours, in particular if the plant leaves are conditioned prior to withering, which represents a significant reduction in time and energy over conventional methods.

According to one further embodiment, the plant leaves can be rolled less than 30 minutes, preferably less than 15 minutes and most preferably less than 10 minutes, in particular if the plant leaves are conditioned either prior to withering and/or prior to rolling.

According to one further embodiment, the plant leaves can be fermented less than 60 minutes, preferably less than 40 minutes and most preferably less than 20 minutes, in particular if the plant leaves are conditioned prior to withering and/or prior to rolling and/or prior to fermenting.

According to one embodiment, fermentation can take place during the steps following conditioning, in particular during rolling and/or during drying. In this embodiment, a separate fermentation step can be omitted.

According to one further embodiment, the plant leaves can be dried less than 30 minutes, preferably less than 15 minutes and most preferably less than 10 minutes, in particular if the plant leaves are conditioned prior to withering and/or prior to rolling and/or prior to fermenting and/or prior to drying.

The present invention further relates to plant leaves for the production of a fermented product, for example a tobacco-, herbal, spice or tea product, which have been conditioned according to the method of the invention, as well as a fermented product, which was produced according to the method of the invention for the production of a fermented product.

In the following, the invention shall be described by way of example in more detail using advantageous embodiments with reference to the drawings and subsequent trial examples. The advantageous further developments and configurations illustrated there are each independent of each other and can be combined with one another, in dependence of the requirement of the application,

where

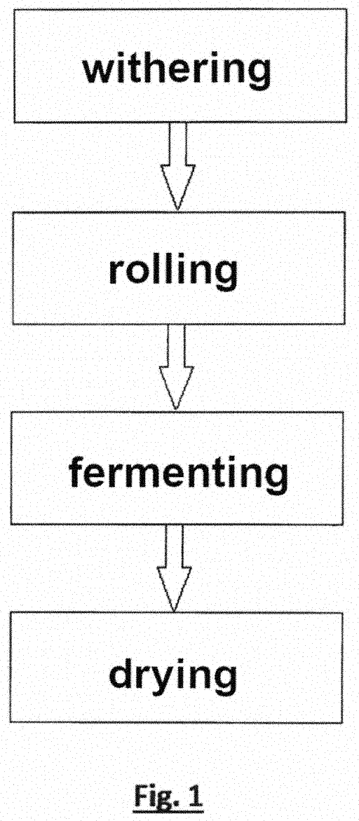

FIG. 1 shows a flow diagram of the method steps in processing plucked tea leaves in the context of the production of a tea product;

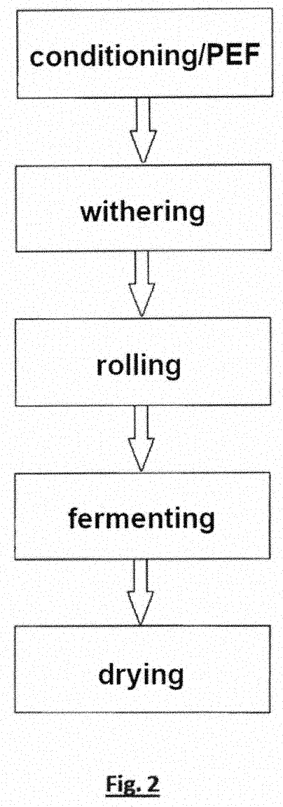

FIG. 2 shows a flow diagram of one embodiment of a method according to the invention;

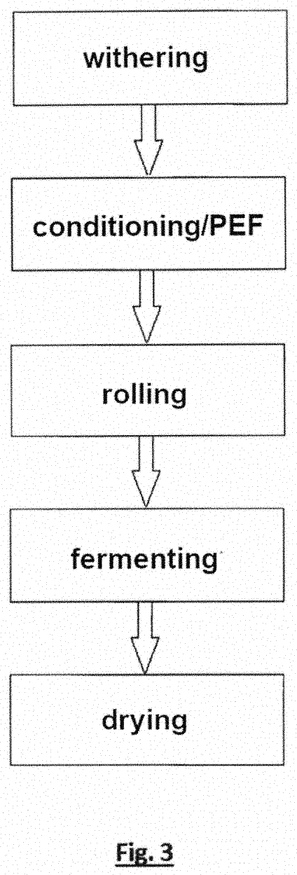

FIG. 3 shows a flow diagram of a further embodiment of the method according to the invention;

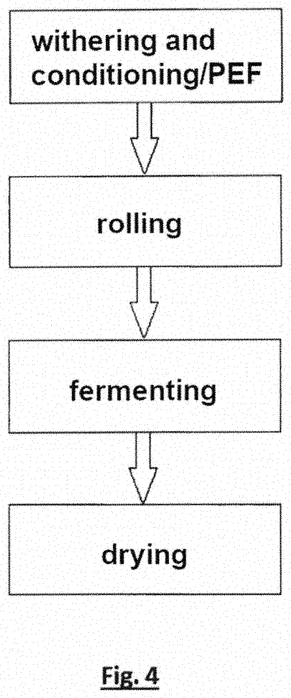

FIG. 4 shows a flow diagram of a third embodiment of the method according to the invention;

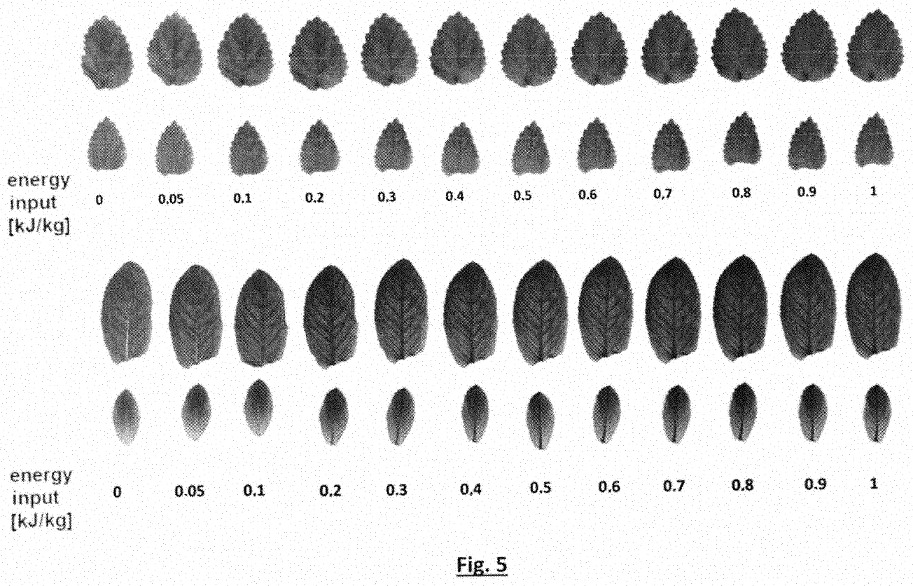

FIG. 5 shows the color change of melissa/balmn leaves (top) and mint leaves (bottom) in dependence of the energy input during conditioning according to the invention;

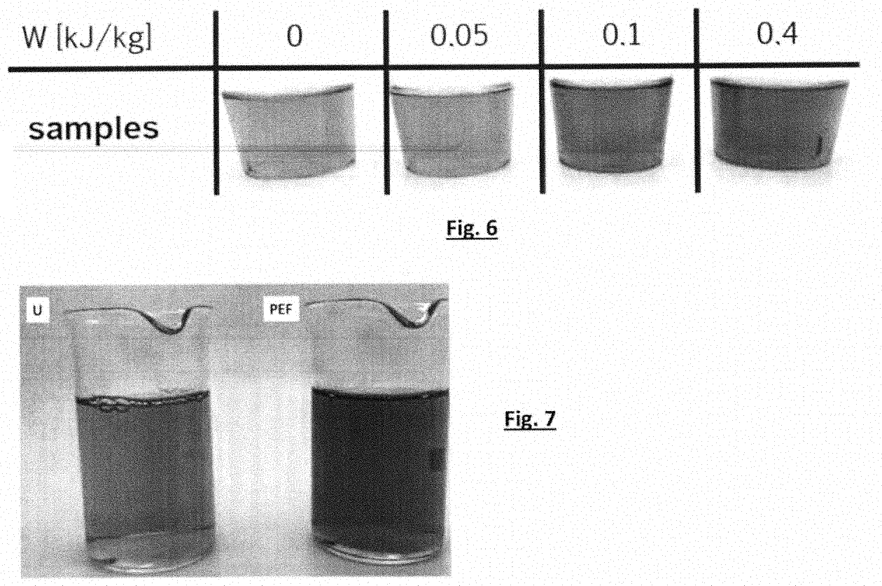

FIG. 6 shows the color change of a mint leaf extract in dependence of the energy input (W) during conditioning: and

FIG. 7 shows the color difference between an unconditioned tea leaf extract (U) and a tea leaf extract (PEF) conditioned according to the invention.

A conventional method for processing tea leaves and for producing a tea product from plucked tea leaves, respectively, shall below be presented with reference to the flow diagram of FIG. 1. The conventional methods for producing tobacco products are very similar. The present invention shall be explained below by way of example for processing tea leaves.

The flow diagram of FIG. 1 outlines the sequence of method steps using in the example of traditional black tea production.

After having been plucked, the tea leaves undergo the following processing stages: withering, rolling, fermenting and drying.

During the withering step, moisture is removed from the plucked tea leaves to soften them. With conventional withering, the tea leaves are exposed to temperatures of about 20° C. for a period of 18 to 24 hours

Withering is followed by the processing step of rolling. Rolling in the sense of the present invention comprises both the initial orthodox method, in which the leaves are broken open with the aid of press spindles or rollers, so that the leaking cell juice combines with the oxygen of the air. But also the CTC treatment, in which the leaf material is first broken, then torn and finally rolled, is to be included in “rolling” in the sense of the present invention. Conventional rolling typically takes at least 30 minutes.

With black tea, the rolled tea leaves are fermented. Fermentation of tea is an oxidation process in which oxidation and fermentation processes are initiated at elevated humidity and temperatures often above room temperature (21° C.), whereby the tea leaves of the black tea take on their copper-red to brown coloring and develop the aromas characteristic of them.

Fermentation is stopped by drying the leaf material at high temperatures above 80° C. for 20 minutes or more.

Further process steps, for example, sieving, sorting and/or mixing tea leaves, can follow drying.

The method of the invention according to a first embodiment, which is shown in the flow diagram of FIG. 2, was characterized by the fact that the tea leaves are conditioned by applying an electric field prior to withering.

For example, an electric field from 0.1 kV/cm to 10 kV/cm can be applied for conditioning, where at least 10 electric pulses, preferably 10 to 200 electric pulses and most preferably 30 to 50 electric pulses can be introduced into the tea leaves, which corresponds to an energy input of, for example, 0.1 kJ/kg to 10 kJ/kg into the tea leaves.

According to one embodiment, conditioning can be carried out in the context of a PEF method in which a pulsed electric field causing cell disruption is applied. During conditioning, a predetermined degree of disruption of the tea leaves can be set in this manner, and the degree of oxidation of the tea leaves can be controlled in this manner during the subsequent fermentation or the duration of the processing, and the processing temperatures in the subsequent processing stages withering, rolling, fermenting and/or drying can be reduced.

A second embodiment of an exemplary method according to the invention is shown in the flow diagram of FIG. 3.

The example of FIG. 3 corresponds substantially to the method of the first embodiment from FIG. 2, but differs in that, with the method of the second embodiment from FIG. 3, the step of conditioning the tea leaves does not take place prior to, but after the step of withering and prior to the step of rolling.

In the flow diagram of FIG. 4, an exemplary third embodiment of a method according to the invention is shown.

The method of the third embodiment is characterized by the fact that the tea leaves are conditioned by applying an electric field during withering.

It is just as conceivable to condition the tea leaves during rolling, or during or prior to any s processing stage prior to drying.

Repeated conditioning is also conceivable by applying an electric field in order to prepare the tea leaves selectively for the subsequent processing stage.

### TRIAL EXAMPLES

In the following, exemplary trials are presented, which demonstrate that the method according to the invention leads in an advantageous manner to improved plant leaf products.

### Trial Example 1

In a first trial, herb leaves as plant leaves were conditioned with an energy input at varying levels. In the trail example 1, balm leaves and mint leaves were conditioned.

FIG. 5 shows the color change in dependence of the energy input.

As can be seen in FIG. 5, the higher the energy input, the darker the plant leaves become. This is related to enzymatic (tanning) oxidation when the intra- and extracellular components react with oxygen. The present trial shows that the method according to the invention for processing plant leaves accelerates this tanning process, where it is noteworthy that enzymatic tanning begins already at a very low energy input of 0.05 to 0.1 kJ/kg. It was possible to show the same effect for a number of other plant leaves, for example, for tea leaves.

It has therefore surprisingly turned out that the method according to the invention for processing plant leaves causes an acceleration of the enzymatic oxidation process

### Trial Example 2

In a further trial, plant leaves (balm leaves, mint leaves and tea leaves) processed, fermented and dried according to the invention were extracted in boiling water. For this purpose, 1 g of leaves of balm, mint and tea, processed according to the invention, were transferred into a tea bag and extracted in a measuring cup with 50 g of boiling water (100° C.) for 10 minutes. After the extraction process, the samples obtained were examined and compared.

The trial results can be seen in FIG. 6 as color differences of dried mint leaves in dependence of the energy input.

FIG. 7 illustrates the color difference of fermented non-processed tea leaves and those processed according to the invention.

FIGS. 6 and 7 show that the method according to the invention accelerates the extraction of color and flavoring ingredients from the plant leaves, which is reflected in stronger tanning of the plant leaf extract.

The higher the specific energy input, the better the ingredients of the tea leaf product can be extracted.

The visual results were also confirmed in a sensory taste test, which showed that conditioning according to the invention leads to a more intense taste of the plant leaf extract. The higher the specific energy input, the more intense the taste of the plant leaf product.

1. Method for processing plant leaves, in particular in the context of producing a fermented product, in which said plant leaves are conditioned by applying an electric field.

2. Method according to claim 1, wherein said plant leaves are tea leaves, spice leaves, herb leaves or tobacco leaves.

3. Method according to claim 1, wherein an electric field of 0.1 kV/cm to 10 kV/cm is applied during conditioning and/or where an energy input of 0.1 kJ/kg to 10 kJ/kg is effected into said plant leaves.

4. Method according to claim 1, wherein a pulsed electric field is applied during conditioning which causes cell disruption.

5. Method according to claim 1, wherein a predetermined degree of disruption of said plant leaves is adjusted during conditioning.

6. Method according to claim 1, wherein conditioning disrupts said plant leaves non-thermally and prepares said plant leaves for a subsequent processing step of withering, rolling, fermenting and/or drying.

7. Plant leaves for the production of a fermented product which have been conditioned according to the method according to claim 1.

8. Method for producing a fermented product from plucked plant leaves comprising the steps of:
optionally withering said plant leaves,
optionally rolling said plant leaves,
optionally fermenting said plant leaves, and
drying said plant leaves,
wherein said plant leaves are further conditioned according to the method of claim 1.

9. Method according to claim 8, wherein said plant leaves are conditioned prior to withering, prior to rolling, during withering, during rolling, prior to fermenting and/or prior to drying.

10. Method according to claim 8, wherein the step of conditioning replaces in whole or in part the step of withering and/or the step of rolling.

11. Method according to claim 8, wherein said plant leaves wither less than 8 hours.

12. Method according to claim 8, wherein said plant leaves are rolled less than 30 minutes, preferably less than 15 minutes and most preferably less than 10 minutes.

13. Method according to claim 8, wherein said plant leaves are fermented less than 60 minutes, preferably less than 40 minutes and most preferably less than 20 minutes.

14. Method according to claim 8, wherein said plant leaves are dried less than 30 minutes, preferably less than 15 minutes and most preferably less than 10 minutes.

15. Plant leaf product produced according to the method of claim 1.

16. Fermented product made of plant leaves produced according to the method of claim 1.

17. Method according to claim 9, wherein the step of conditioning replaces in whole or in part the step of withering and/or the step of rolling.

18. Method according to claim 9, wherein said plant leaves wither less than 8 hours.

19. Method according to claim 9, wherein said plant leaves are rolled less than 30 minutes, preferably less than 15 minutes and most preferably less than 10 minutes.

20. Method according to claim 9, wherein said plant leaves are fermented less than 60 minutes, preferably less than 40 minutes and most preferably less than 20 minutes.
